(19) United States
(12) Patent Application Publication
(10) Pub. No.: US 2009/0083035 A1
(43) Pub. Date: Mar. 26, 2009

(54) TEXT PRE-PROCESSING FOR TEXT-TO-SPEECH GENERATION

(76) Inventors: Ritchie Winson Huang, Torrance, CA (US); David Michael Kirsch, San Pedro, CA (US)

Correspondence Address: O'Melveny & Myers LLP;IP&T Calendar Department LA-1118, 400 South Hope Street, Los Angeles, CA, 90071-2899, US

(21) Appl. No.: 11/861,247

(22) Filed: Sep. 25, 2007

(51) Int. Cl. G10L 13/00

(52) U.S. Cl. 704/260

(57) ABSTRACT

A system and method are provided for improved speech synthesis, wherein text data is pre-processed according to updated grammar rules or a selected group of grammar rules. In one embodiment, the TTS system comprises a first memory adapted to store a text information database, a second memory adapted to store grammar rules, and a receiver adapted to receive update data regarding the grammar rules. The system also includes a TTS engine adapted to retrieve at least one text entry from the text information database, pre-process the at least one text entry by applying the updated grammar rules to the at least one text entry, and generate speech based at least in part on the least one pre-processed text entry.

### BACKGROUND OF THE INVENTION

1. Field of the Invention

The present invention generally relates to a system and method for dynamically updating and using text-to-speech data. More specifically, the present invention relates to dynamically updating the grammar rules used to pre-process text information database entries to achieve improved output text-to-speech phonetics.

2. Description of Related Art

Systems incorporating text-to-speech engines or synthesizers coupled to a database of textual data are well known and continue to find an ever-increasing number of applications. For example, automobiles equipped with text-to-speech and speech-recognition capabilities simplify tasks that would otherwise require a driver to take away his/her attention from driving. The uses of text-to-speech output in a vehicle include, but are not limited to, controlling electronic systems aboard the vehicle, such as navigation systems, audio systems, etc.

While the increasing applicability of text-to-speech (TTS) systems to electronic systems and devices, others have attempted to improve the output of text-to-speech phonetics, i.e., make the synthesized speech more natural or understandable for users. Toward this end, others have implemented a variety of fixed dictionaries. However, fixed dictionaries are necessarily large in order to handle a sufficiently large vocabulary. Moreover, a relatively high speed processor is needed to locate and retrieve entries from such large dictionaries with sufficient speed.

Others have attempted to implement non-fixed dictionaries where certain textual data are pre-processed to achieve improved TTS output. Others have attempted to pre-process the textual data according to defined rules or via manual editing of textual database entries. Such approaches to pre-processing can be time-consuming and inefficient. Moreover, a given set of pre-processing or grammar rules for a particular application may be outdated or inappropriate for another application or scenario.

Accordingly, it would be desirable to provide a system that can pre-process textual data with grammar rules that can be updated or adjusted for particular applications, user preferences, etc. Such a system would have the benefit of non-fixed dictionaries and updateable grammar rules with which to pre-process entries in the non-fixed dictionaries.

### SUMMARY OF THE INVENTION

The present invention provides a system and method for improving the performance of text-to-speech (TTS) systems by dynamically updating the grammar rules used to pre-process textual entries in a text information database.

In accordance with one aspect of the embodiments described herein, there is provided a system for pre-processing text for TTS generation, comprising a first memory adapted to store a text information database, a second memory adapted to store grammar rules, a receiver adapted to receive update data regarding the grammar rules and relay the received update data to the second memory, and an audio output device. The system further comprises a TTS engine operatively coupled to the first and second memories, the receiver, and the audio output device, wherein the TTS engine is adapted to: (a) retrieve at least one text entry from the text information database; (b) apply the updated grammar rules to the at least one text entry, and thereby pre-process the at least one text entry; (c) generate speech based at least in part on the least one pre-processed text entry; and (d) send the generated speech to the audio output device.

In accordance with another aspect of the embodiments described herein, there is provided a system pre-processing text for TTS generation, comprising a memory adapted to store a text information database and grammar rules, a receiver to receive a request for the TTS generation, and an audio output device. The system further comprises a TTS engine operatively coupled to the memory, the receiver, and the audio output device, wherein the TTS engine is adapted to: (a) retrieve at least one text entry from the text information database according to the received request for the TTS generation; (b) retrieve a subset of rules from the grammar rules according to the received request; (c) apply the retrieved rules to the at least one text entry, and thereby pre-process the at least one text entry; (d) generate speech based at least in part on the at least one pre-processed text entry; and (e) send the generated speech to the audio output device.

In accordance with another aspect of the embodiments described herein, there is provided a method for pre-processing text for a TTS engine according to grammar rules, comprising: (a) receiving update data regarding the grammar rules; (b) updating the grammar rules according to the received update data; (c) receiving a request for TTS generation; (d) retrieving at least one text entry from a text information database; (e) applying the updated grammar rules to the at least one text entry to pre-process the at least one text entry. The method can further comprise providing an audio output with TTS phonetics based at least in part on the at least one pre-processed text entry.

### BRIEF DESCRIPTION OF THE DRAWINGS

FIG. 1 is a schematic diagram of one embodiment of a TTS system;

FIG. 2 is a schematic diagram of another embodiment of a TTS system;

FIG. 3a is a schematic diagram of an embodiment of a communication system pursuant to aspects of the invention;

FIG. 3b is a schematic diagram of a navigation device in communication with a mobile unit according to an embodiment of the invention;

FIG. 4 is a block diagram of an embodiment of a multi-packet dedicated broadcast data message;

FIG. 5 is a diagram illustrating a subcarrier of a radio signal; and

FIG. 6 is a schematic diagram illustrating an embodiment of a modified broadcast data stream.

### DETAILED DESCRIPTION OF THE PREFERRED EMBODIMENT

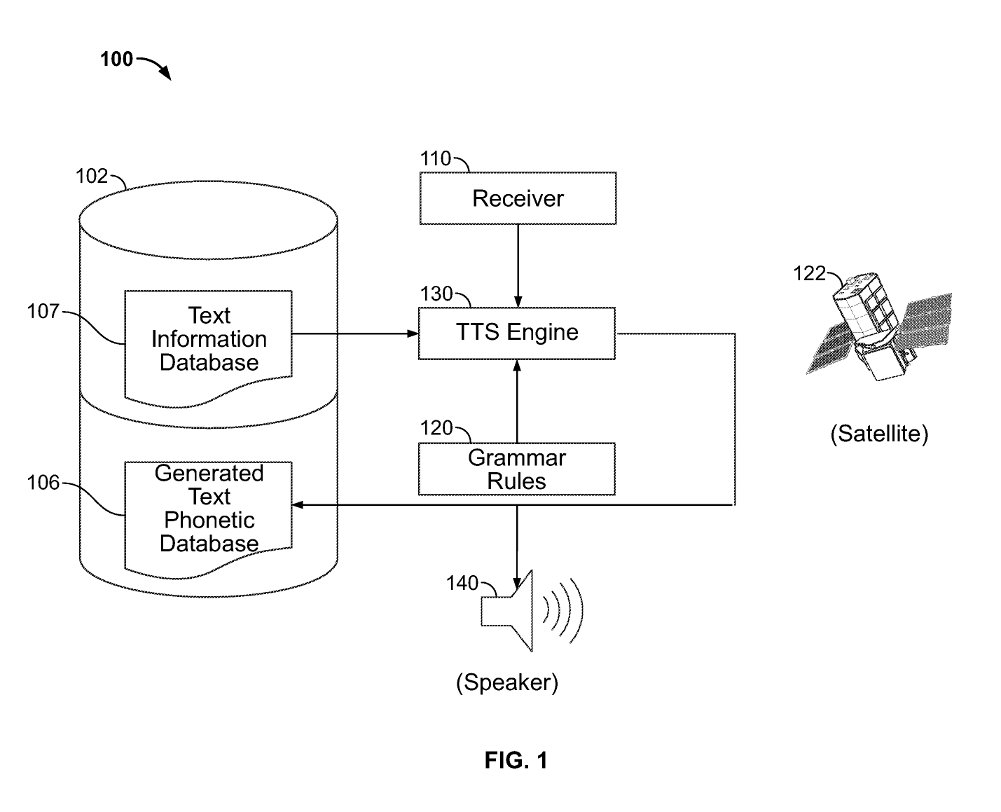

FIGS. 1-7 illustrate several embodiments of a system and method for pre-processing text to improve the phonetic properties of the text before the text is further processed by a text-to-speech (TTS) engine or module. While the following description of the exemplary system is directed to an application of TTS engines for controlling vehicle navigation systems and other embedded systems, it should be appreciated that the system would apply equally well to other vehicle-related TTS applications, as well as other non-vehicle related TTS applications.

FIG. 1 illustrates one exemplary embodiment of a TTS system 100. In this embodiment, TTS system 100 includes, among other things, a memory 102, a receiver 110, a TTS module or engine 130, and a set of grammar rules 120. The memory 102 can comprise, for example, a hard disk drive or the like. The memory 102 stores a text information database 104 and a generated phonetic database 106, explained in further detail below. The TTS engine 130 can comprise any conventional text-to-speech converter or reader known in the art. The grammar rules 120 generally comprise a set of rules used by the TTS engine 130 to generate a phonetic database 106, which is in turn used to output TTS phonetics via an audio output device 140, comprising speakers or the like, in response to an input request for TTS generation 110 received by the receiver 110. The grammar rules 120 can be stored on the memory 102 or another memory that is separate from the memory 102, such as cache, flash memory, or separate hard disk drive or the like.

The receiver 110 is adapted to receive, among other things, requests for TTS generation. The receiver 110 relays the request to the TTS engine 130, which in turn accesses and uses the grammar rules 120 to pre-process entries in the text information database 104 to generate a phonetic database 106. The TTS engine 130 processes or converts the entries in the text information database 102 and then reads selected entries from the generated phonetic database 106 for the user. In the embodiment of FIG. 1, the TTS engine 130 stores the generated phonetic database 106 on the memory 102. In another embodiment, the TTS engine 130 stores the generated phonetic database 106 or selected entries thereof on memory that is separate from the memory 102. The output TTS phonetics resulting from the application of the grammar rules 120 to selected entries of the text information database 104 is played for the user via the audio output device 140.

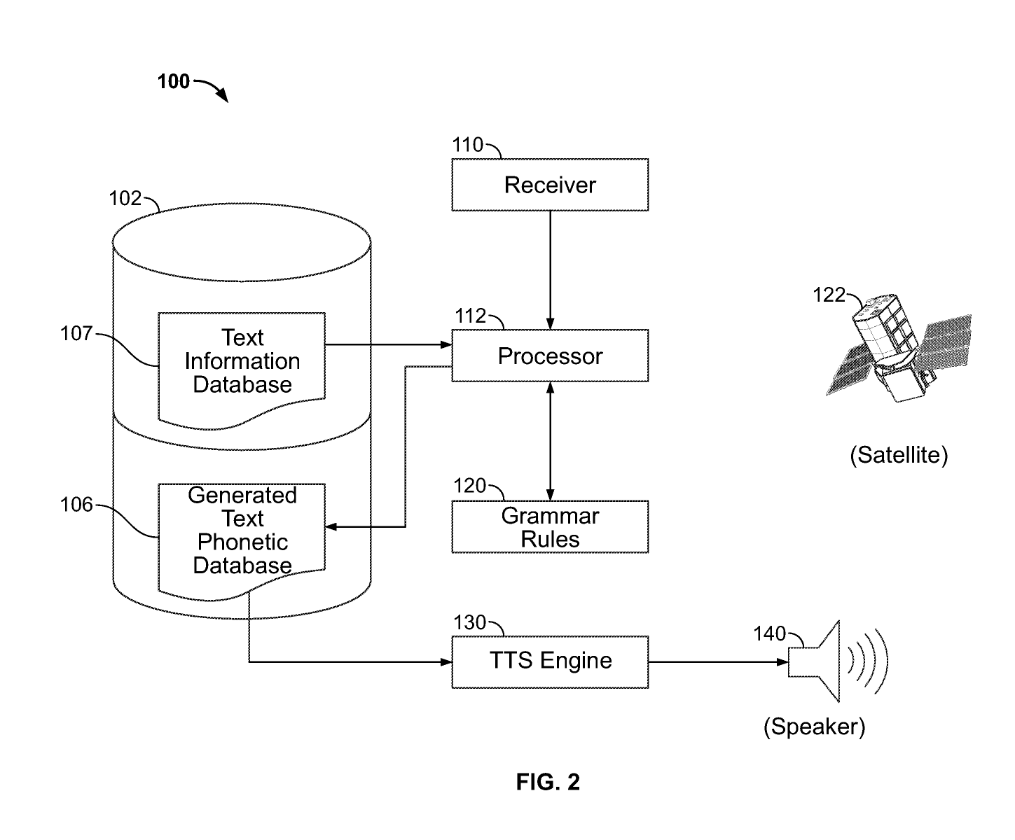

FIG. 2 illustrates another embodiment of a TTS system 100 that includes, among other things, a memory 102, a receiver 110, a processor 112, a TTS engine 130, and a set of grammar rules 120. The receiver 110 is adapted to receive, among other things, requests for TTS generation. The receiver 110 relays the request to the processor 112, which in turn accesses and uses the grammar rules 120 to pre-process entries in the text information database 102 to generate a phonetic database 106. The processor 112 converts entries in the text information database 104 and generates a phonetic database 106. The TTS engine reads selected entries from the generated phonetic database 106 to output TTS phonetics for the user via the audio output device 140. In the embodiment of FIG. 2, the processor 112 stores the generated phonetic database 106 on the memory 102. In another embodiment, processor 112 stores the generated phonetic database 106 or selected entries from thereof on memory that is separate from the memory 102, such as cache, flash memory, or separate hard disk drive or the like.

The grammar rules 120 are used for automatically producing phonetics that can be saved for later use or used immediately for both TTS and voice recognition purposes. The grammar rules 120 can be stored in any suitable memory that is part of or operatively coupled to the TTS system 100. The grammar rules 120 can be stored with or apart from the text information database 104 and/or the phonetic database 106. The grammar rules 120, regardless of where they are stored, make it possible for the TTS engine 130 or equivalent thereof to pre-process text to achieve better prosody of voice and comprehensibility by the user. The TTS engine 130 or separate processor 112 can be used to go through the text data 104 and generate the raw phonetics 106, thereby allowing automated text manipulation for embedded or mobile TTS engines.

In one embodiment, the grammar rules 120 comprise rules for removal, reformatting, and/or replacement of text based on word spelling (including abbreviations), word and sentence structure, or other formatting structures. The TTS engine 130 or processor 112 uses search algorithms and preprocesses (i.e., removes, reformats, or replaces) entries in the text database 104 to produce a partial or complete phonetic database 106. The phonetic database 106 can be used by TTS and/or voice recognition engines.

The removing technique involves searches for particular items and removal of the identified particular items from the database entries. The removing technique can be for specific words or phrases, as well for punctuation items, such as parenthesis. The purpose of removing words, phrases, or punctuation is to eliminate portions of text database entries that are inappropriate for the TTS engine or will likely cause confusion for the user. Examples of grammar rules 120 for removing symbols include:

| | Description |
|---|---|
| Item | (replace with a single space) |
| ... | Triple periods |
| !! | Double exclaimation |
| .. | Double periods |
| : | Colon |
| ? | Question Mark |
| _{—} | Underscore |
| \ | Backslash |
| * | Asterick |
| ” | Double quotes |
| [symbol] | Inverted question mark |
| / | Forward slash |

The reformatting technique involves searches for particular items and changing all or part of the makeup of identified text database entries, such as providing alternative spellings for a mispronounced word or providing letter/word markups for optimum TTS generation. Depending on the particular application of the TTS system, grammar rules 120 appropriate for a given application, such as vehicle audio or music systems, are utilized. For example, in the context of audio systems, the grammar rules 120 can comprises an algorithm for reformatting “Live”, such that “Greatest Hits (Live)” becomes “Greatest Hits Live” (hard wound Lyve). In another example, the grammar rules 120 comprise a zero-to-O algorithm, such that “808 State” becomes “Eight Oh Eight State”. Examples of grammar rules 120 for reformatting classical music composer names can include:

| Composer Name | Reformatted Composer Name |
|---|---|
| Alfred Schnittke | AE L F R IX DD SH N IH TD K IX |
| Antonin Dvorák | AO N T AXR N Y IY N D V AO R ZH AO |
| | KD |
| Franz von Suppé | F R AO N S F AH N S UW P EY |
| Frédéric Chopin | F R EH DX AX R IY KD SH OW P AE N |
| Giacomo Puccini | JH AO K AX M OW P UW CH IY N IY |
| Johann Strauss I | Y OW HH AO N S T R AW S DH IX F ER S |
| | TD |
| Pëtr Il'ich Tchaikovsky | P IY AXR T R IY L Y IY CH CH AY K AO |
| | V S K IY |
| Richard Wagner | R IY SH AA R DD V AO G N AXR |

The replace technique involves searches for particular items and replacing them with appropriate substitute items. This can involve replacing an abbreviation with its full word, or substituting letters or characters with appropriate substitutions. For example, the grammar rules 120 can comprises an algorithm for replacing “&” with “and”, such that “Rock & Roll” becomes “Rock and Roll”. In another example, the grammar rules 120 comprise an algorithm for replacing “feat.” with “featuring”, such that “Union (feat. Sting)” becomes “Union featuring Sting”. Examples of grammar rules 120 for replacing words and symbols include:

| Original | |
|---|---|
| Item | Replacement Item |
| ft. | featuring |
| jan | January |
| feb | February |
| arr. | arranged by |
| conc. | concerto |
| incl. | incl. |
| mvt. | movement |
| sym. | symphony |
| no. | number |
| # | number |
| op. | Opus |
| orch. | orchestra |

Other examples of grammar rules 120 for audio or music systems include can include:

| Grammar Rule | Example | Original | Modified |
|---|---|---|---|
| For entries with one or two | track 002 | track zero zero | track 2 |
| zeros (e.g., 011 or 002), | | two | |
| remove preceding zeros | | | |
| Change capital letters to be | AC DC | Ack DC | A C D C |
| read separately (mm. 2 | | | |
| letters, max. 8 letters), and | | | |
| add spaces between letters | | | |
| When Live is surrounded | Babylon by Bus | Babylon by Bus | Babylon by Bus |
| by parenthesis or brackets, | (Live) | Live | Lyve |
| replace with Lyve | | | |
| Brackets or parentheses | The Pretenders | The Pretenders | The Pretenders |
| may have additional text. | (Live in Las | Live in Las Vegas | Lyve in Las Vegas |
| Keep all of text and only | Vegas) | | |
| make the spelling change | | | |
| Allow multiple entries by | The Beatles (the | The Beatles the | The Beatles; The |
| only saying what is outside | White Album) | White Album | White Album, The |
| or inside the parentheses | | | Beatles the White |
| or brackets | | | Album |

As explained above, particular grammar rules 120 can be selected and used for particular applications. While many of the examples of grammar rules 120 described herein are for audio or music systems, it will be understood that the grammar rules 120 generally can comprise rules for automatically producing phonetics that can be saved for later use or used immediately for both TTS and voice recognition purposes, and are not limited to any particular type of electronic system, such as embedded music, audio, or navigation systems.

TTS data, including but not limited to grammar rules 120, text information 104, and generated text phonetics 106, can be updated via any known approach. For example, in the embodiment of FIGS. 1 and 2, updated grammar rules 120 are transmitted to the TTS system 100 via satellite radio transmission, described in further detail below. The TTS data can be received by the receiver 110 or another receiver (not illustrated) operatively coupled to the memory device on which the grammar rules are stored. In another embodiment, the grammar rules are updated via interfacing a memory device (e.g., portable flash memory device, portable computing device, personal digital assistant, portable music player, etc.) with the TTS system 100.

The TTS system 100 typically comprises a receiver or is in communication with a receiver located on the vehicle that allows the TTS data (e.g., grammar rules 120) to be updated remotely. In one embodiment, the receiver supports the receipt of content from a remote location that is broadcast over a one-to-many communication network. One-to-many communication systems include systems that can send information from one source to a plurality of receivers, such as a broadcast network. Broadcast networks include television, radio, and satellite networks. For example, the grammar rules for TTS pre-processing can be updated by a remote broadcast signal such as via satellite radio broadcast service, as illustrated in FIGS. 1 and 2. The one-to-many communication network may comprise a broadcast center that is further in communication with one or more communication satellites 122 that relay a dedicated broadcast signal or a modified broadcast signal to the receiver located on the vehicle. For example, the broadcast center and the satellites 122 can be part of a satellite radio broadcasting system, such as XM Satellite Radio or the like. It will be understood that the dedicated broadcast signal and modified broadcast signal may be broadcast via any suitable information broadcast system (e.g., FM radio, AM radio, or the like), and is not limited to satellite radio broadcast systems.

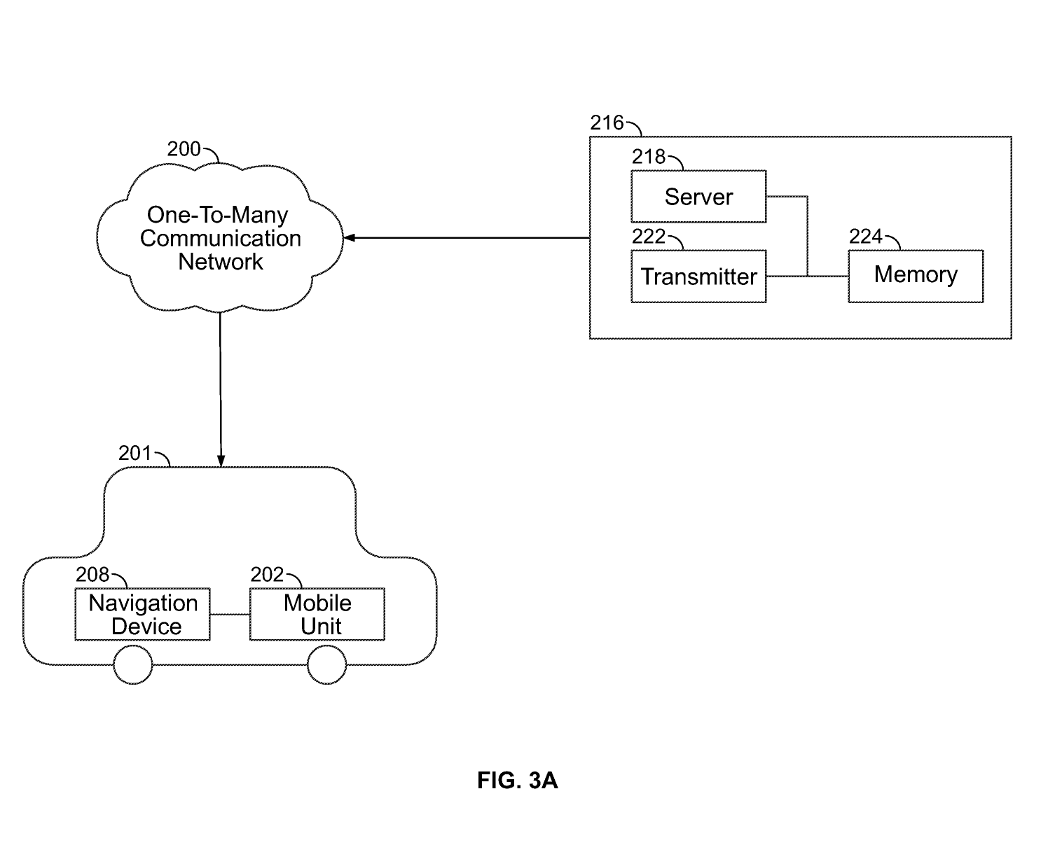

With reference to FIG. 3a, there is provided an embodiment of a system for the exchange of information between a remote location 216 and a vehicle 201. The remote location 216 is a server system for outputting vehicle broadcast data. The vehicle 201 includes a navigation device 208 and a mobile unit 202. The navigation device 208 is an electronic system used to provide driving directions, display of messages to the vehicle operator, and audio playback of messages, radio broadcasts or other media. The navigation device 208 is operatively coupled to the mobile unit 202 and supports the receipt of content from the remote location 216 that is broadcast over a one-to-many communication network 200. One-to-many communication systems include systems that can send information from one source to a plurality of receivers, such as a broadcast network. Broadcast networks include television, radio, and satellite networks. While the illustrative embodiments of the present invention include electronic systems that include a navigation component, it will be understood that the systems and methods described herein are applicable to any electronic system, such as an audio or media system, vehicle-embedded, portable, or otherwise.

In one embodiment, data for the TTS data (e.g., grammar rules 120) is generated at the remote location 216 or an alternate location that is not within or near the vehicle 201, The TTS data is broadcast from the remote location 216 over the one-to-many communication network 200 to the vehicle 201. The mobile unit 202 receives the broadcasted message and can transmit the TTS data to the navigation device 208 for updating of the database of available grammar rules 120 and/or databases 104, 106. With respect to the present illustrative embodiment, the grammar rules 120, text information data 104, and text phonetic data 106 are stored in memory 209 (see FIG. 3b). It will be understood that such TTS data can also be stored in other memory devices on or associated with the vehicle 201.

The remote location 216 can include a remote server 218, a remote transmitter 222, and a remote memory 224, that are each in communication with one another. The remote transmitter 222 communicates with the navigation device 208 and mobile unit 202 by way of the broadcast 200 communication network. The remote server 218 supports the routing of message content over the broadcast network 200. The remote server 218 comprises an input unit, such as a keyboard, that allows the entry of updated grammar rules 120 or the like into memory 224, and a processor unit that controls the communication over the one-to-many communication network 200.

The server 218 is in communication with the vehicle 201 over a one-to-many communication network 200. In the present embodiment, the one-to-many communication network 200 comprises a broadcast center that is further in communication with one or more communication satellites 122 that relay the TTS data to a mobile unit 202 in the owner's vehicle 201. In the present embodiment, the broadcast center and the satellites 122 are part of a satellite radio broadcasting system, such as XM Satellite Radio or the like. It will be understood that the TTS data can be broadcast via any suitable information broadcast system (e.g., FM radio, AM radio, or the like), and is not limited to the satellite radio broadcast system. In one embodiment, the mobile unit 202 relays the safety message to an onboard computer system, such as the vehicle's navigation system 208, which in turn updates the database of TTS data, such as grammar rules 120, text information data 104, text phonetic data 106, etc.

FIG. 3b shows an expanded view of both the navigation device 208 and the mobile unit 202 contained on the vehicle 201. The navigation device 208 may include an output unit 214, a receiver unit 215, an input unit 212, a TTS engine 210, a navigation memory unit 209, a navigation processor unit 213, and an RF transceiver unit 211 that are all in electrical communication with one another. The navigation memory unit 209 can store TTS data, such as grammar rules 120 and/or text information 104 and/or text phonetics 106. Alternately, the TTS data or components thereof can be stored in memory that is not part of the navigation device 208. The database(s) with TTS grammar rules 120 and/or text information 104 and/or text phonetics 106 can be updated in the vehicle by way of the input unit 212, which can include a keyboard, a touch sensitive display, jog-dial control, etc. The TTS data can also be updated by way of information received through the receiver unit 215 and/or the RF transceiver unit 211.

The receiver unit 215 receives information from the remote location 216 and, in one embodiment, is in communication with the remote location by way of a one-to-many communication network 200 (see FIG. 3a). The information received by the receiver 215 may be processed by the navigation processor unit 213. The processed information may then be displayed by way of the output unit 214, which includes at least one of a display and a speaker. In one embodiment, the receiver unit 215, the navigation processor unit 213 and the output unit 214 are provided access to only subsets of the received broadcast information.

In the embodiment shown in FIG. 3b, the mobile unit 202 includes a wireless receiver 204, a mobile unit processor 206, and an RF transceiver unit 207 that are in communication with one another. The mobile unit 202 receives communication from the remote location 216 by way of the receiver 204. In one embodiment, the navigation device 208 and mobile unit 202 are in communication with one another by way of RF transceiver units 207 and 211. Both the navigation device 208 and the mobile unit 202 include RF transceiver units 211, 207, which, in one embodiment, comply with the Bluetooth® wireless data communication format or the like. The RF transceiver units 211, 207 allow the navigation device 208 and the mobile unit 202 to communicate with one another.

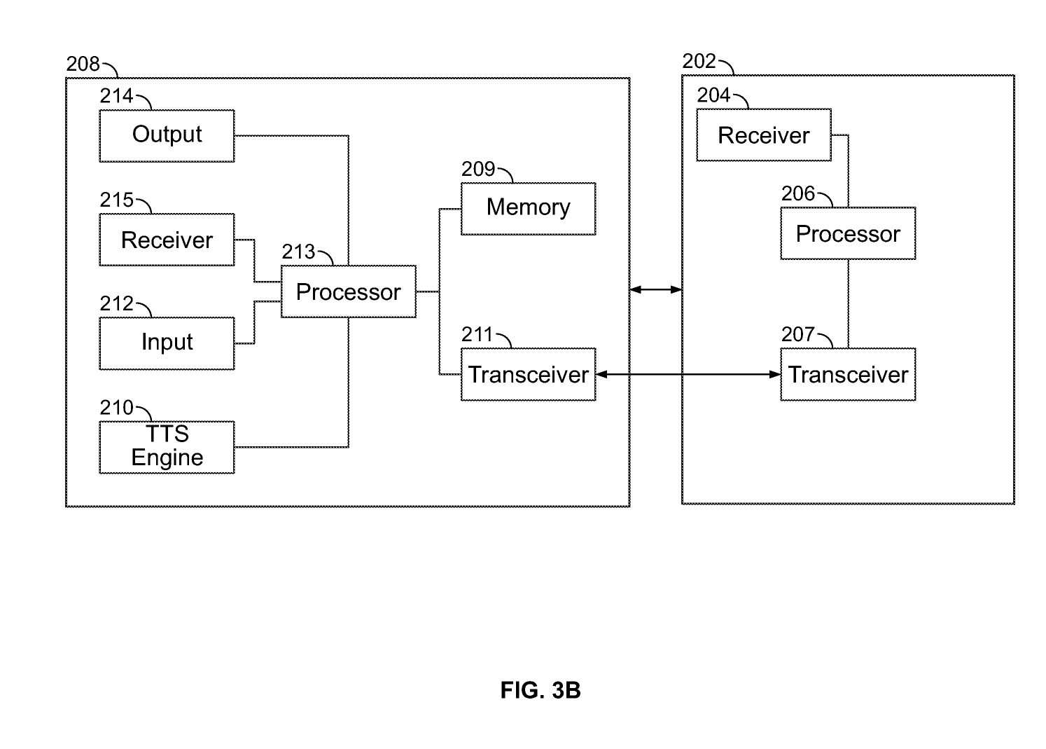

In embodiments that involve broadcasting the TTS data to affected vehicle owners, one or a few messages may be transmitted over a one-to-many communication network 200 that each comprise a plurality of one-to-one portions (shown in FIG. 4), as opposed to transmitting a separate message for each vehicle. Each one-to-one portion will typically be applicable to a single affected vehicle and allows for the broadcast of targeted vehicle information over a one-to-many network 200 using less bandwidth than if each message was sent individually. When broadcasting a message over a one-to-many communication network 200, all vehicles 201 within range of the network 200 may receive the message, however the message will be filtered by the mobile unit 202 of each vehicle 201 and only vehicles 201 specified in the one-to-one portions of the message will store the message for communication to the vehicle owner. In one embodiment, each one-to-one portion comprises a filter code section. The filter code section can comprise a given affected vehicle's vehicle identification number (VIN) or another suitable vehicle identifier known in the art. The vehicle identifier will typically comprise information relating to the vehicle type, model year, mileage, sales zone, etc., as explained in further detail in U.S. patent application Ser. No. 11/232,2001, filed Sep. 20, 2005, titled “Method and System for Broadcasting Data Messages to a Vehicle,” the content of which is incorporated in its entirety into this disclosure by reference.

TTS updates can be received via a dedicated broadcast data stream. The dedicated data stream utilizes a specialized channel connection, such as the connection for transmitting traffic data described in U.S. patent application Ser. No. 11/266,879, filed Nov. 4, 2005, titled “Data Broadcast Method for Traffic Information,” the disclosure of which is incorporated in its entirety herein by reference. For example, the XM Satellite Radio signal uses 12.5 MHz of the S band: 2332.5 to 2345.0 MHz. XM provides portions of the available radio bandwidth to certain companies to utilize for specific applications. The transmission of messages over the negotiated bandwidth would be considered to be a dedicated data stream. In a preferred embodiment, only certain vehicles would be equipped to receive the dedicated broadcast signal or data set. The broadcast signal may comprise, by way of example only, a digital signal, FM signal, WiFi, cell, a satellite signal, a peer-to-peer network and the like. The TTS data can be embedded into the dedicated broadcast message received at the vehicle.

To install new TTS data in the vehicle, the dedicated radio signal, containing one or a plurality of new or updated TTS phonetics and/or grammar rules, is transmitted to each on-board vehicle receiver unit 204. With a dedicated signal, the in-vehicle hardware/software architecture would be able to accept this signal. In an exemplary embodiment, after the mobile unit receiver 204 receives a broadcast signal, the receiver 204 transmits the dedicated broadcast signal to the on-board vehicle processor 206. The broadcast signal is then deciphered or filtered by the processor 206. For example, the processor 206 filters out the TTS phonetics and/or grammar rules from the other portions of the dedicated broadcast signal (e.g., traffic information, the radio broadcast itself, etc.). The other portions of the broadcast signal are sent to the appropriate in-vehicle equipment (e.g., satellite radio receiver, navigation unit, etc.).

In the present embodiment, the TTS data is sent by the processor 206 to the navigation device 208, and is stored in the on-board memory 209 of the device. This updated TTS data, once stored in the on-board memory 209, is then available to the TTS 210. The on-board memory 209 may comprise any type of electronic storage device such as, but not limited to, a hard disk, flash memory, or the like. The on-board memory 209 may be separate from the navigation device 208 or integrated into it. The function of the on-board memory 209 can be dedicated to storing only TTS data or may comprise a multi-function storage capacity by also storing other content such as digital music and navigation-related information.

The navigation device 208 preferably includes an electronic control unit (ECU) (not shown). The ECU processes the TTS data received by the receiver 204 so that the TTS data is stored in the appropriate memory, such as on-board memory 209, memory 102, etc., and can be used by the system. In the present embodiment, TTS data is transmitted to the vehicle and is stored in the on-board memory 209. The ECU organizes and formats the data stored in the memory 209 into a format that is readable by the system, and in particular, so that the TTS engine 210 can read the data.

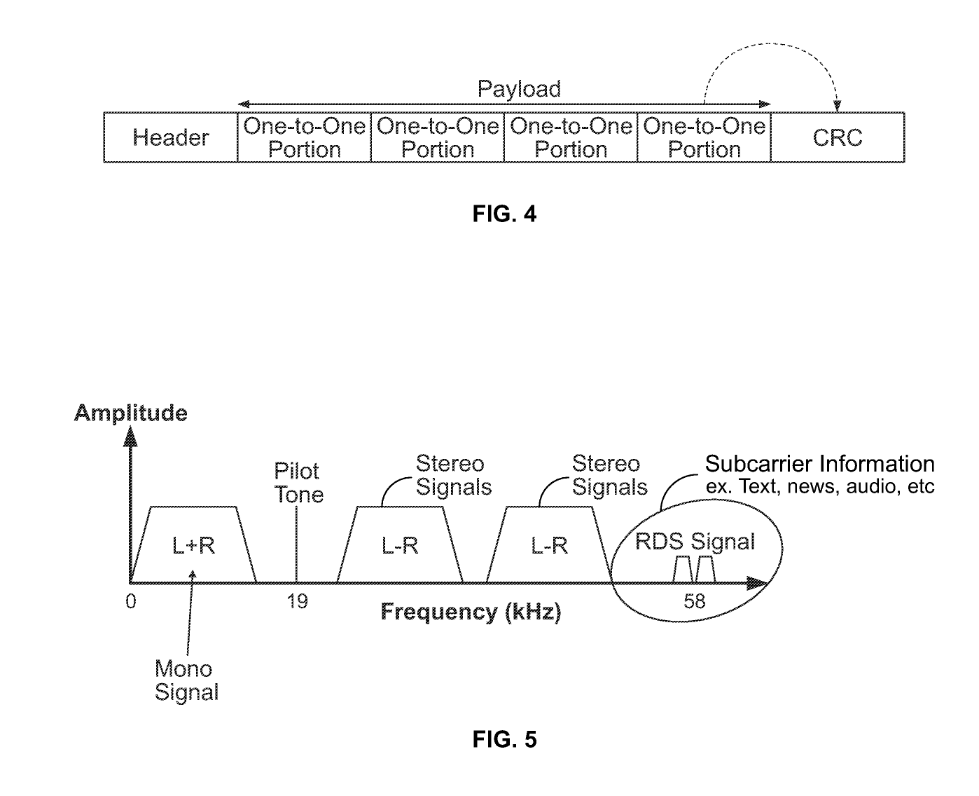

In another embodiment, shown in FIG. 5, updates to the TTS data are transmitted to the vehicle via a modified broadcast signal. The TTS data may be transmitted in a subcarrier of the radio signal such as in a Radio Data System (RDS) signal shown in FIG. 5. The subcarrier is a portion of the channel range. The outlying portions of the radio frequency range are often used for additional transmission (i.e., text data). Song titles, radio station names, and stock information are commonly transferred today. It should be appreciated that the subcarrier may be used to carry TTS data in any radio signal (e.g., FM, AM, XM, Sirius, etc.). The illustrated embodiment involves transmitting text data pertaining to TTS phonetics by using the extra subcarrier range.

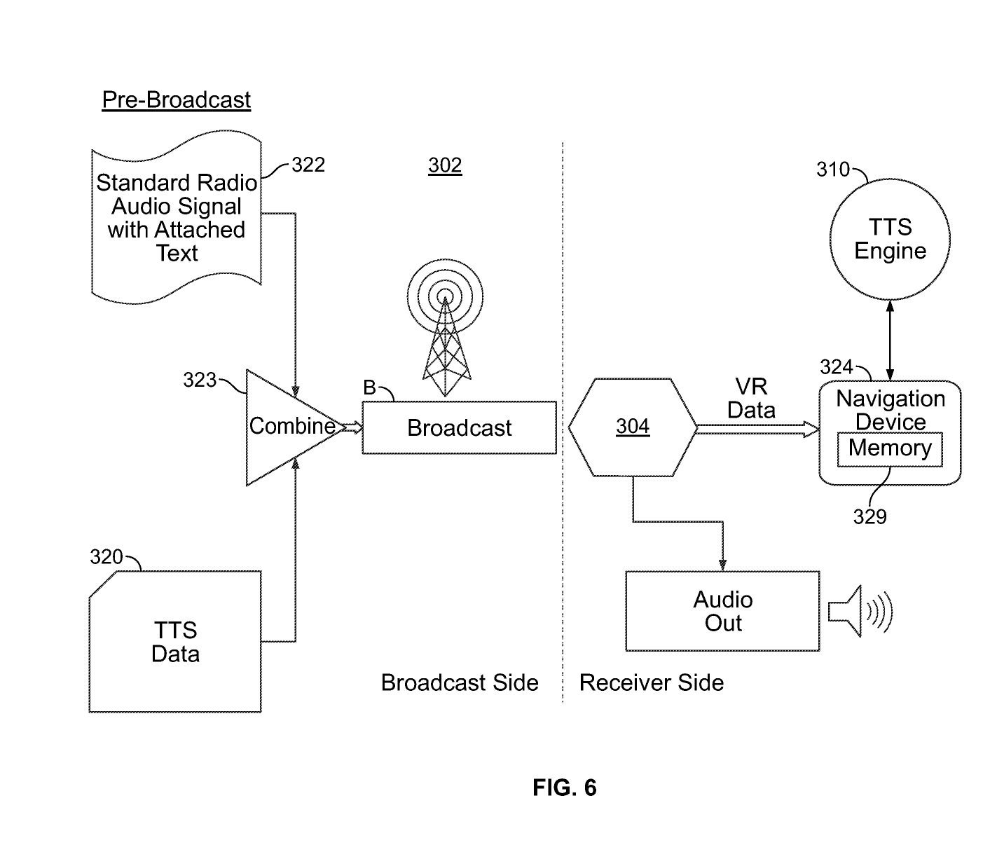

An exemplary modified broadcast signal may be a standard radio audio signal 322 such that the radio signal is modified or combined 323 to also include TTS data 320, as shown in FIG. 6. Combining multiple data streams into a single signal prior to broadcast is well known within the electronic arts. In the present embodiment, the modified broadcast signal updates the TTS stored in a navigation device 324. The modified broadcast signal, similar to the dedicated broadcast signal shown in FIG. 4, can transmit signals through various channels (e.g., radio, satellite, WiFi, etc.). The receiver unit 304 of the vehicle receives the TTS data 320 along with the radio audio signal 322. The receiver unit 304 separates the TTS data 320 from the radio audio signal 322 as is conventionally done with channel, category, and song information, and is known within the art. The TTS data 320 is sent to the navigation device 324 and stored in the memory 329. The TTS data 320 can further comprise TTS data for other equipment in the vehicle, such as the air conditioning system, power windows, and so on.

It should be appreciated that the above-described methods for dynamically updating and utilizing in-vehicle TTS data are for explanatory purposes only and that the invention is not limited thereby. Having thus described a preferred embodiment of a method and system for dynamically updating TTS data, it should be apparent to those skilled in the art that certain advantages of the described method and system have been achieved. It should also be appreciated that various modifications, adaptations, and alternative embodiments thereof may be made within the scope and spirit of the present invention. It should also be apparent that many of the inventive concepts described above would be equally applicable to the use of other electronic systems, and are not limited to vehicle navigation systems.

What is claimed is:

1. A system for pre-processing text for text-to-speech (TTS) generation, comprising:
a first memory adapted to store a text information database;
a second memory adapted to store grammar rules;
a receiver adapted to receive update data regarding the grammar rules and relay the received update data to the second memory;
an audio output device; and
a TTS engine operatively coupled to the first and second memories, the receiver, and the audio output device, the TTS engine being adapted to:
retrieve at least one text entry from the text information database;
apply the updated grammar rules to the at least one text entry, and thereby pre-process the at least one text entry;
generate speech based at least in part on the least one pre-processed text entry; and
send the generated speech to the audio output device;
wherein the audio output device plays the generated speech.

2. The system as recited in claim 1, wherein the at least one pre-processed text entry is stored in a phonetic database.

3. The system as recited in claim 2, wherein phonetic database is stored on the first memory.

4. The system as recited in claim 2, wherein phonetic database is stored on the second memory.

5. The system as recited in claim 1, wherein the receiver receives the update data from a remote location.

6. The system as recited in claim 1, wherein the updated grammar rules comprise instructions for the TTS engine to reformat the at least one text entry to a phonetic spelling different from standard spelling.

7. The system as recited in claim 1, wherein the updated grammar rules comprise instructions for the TTS engine to remove at least one of a word, a phrase, or a punctuation item from the at least one text entry.

8. The system as recited in claim 1, wherein the updated grammar rules comprise instructions for the TTS engine to replace at least one of a word, a phrase, or a punctuation item from the at least one text entry with a substitute item.

9. A system for pre-processing text for text-to-speech (TTS) generation, comprising:
a memory adapted to store a text information database and grammar rules;
a receiver to receive a request for the TTS generation;
an audio output device; and
a TTS engine operatively coupled to the memory, the receiver, and the audio output device, the TTS engine being adapted to:
retrieve at least one text entry from the text information database according to the received request;
retrieve a subset of rules from the grammar rules according to the received request;
apply the retrieved rules to the at least one text entry, and thereby pre-process the at least one text entry;
generate speech based at least in part on the least one pre-processed text entry; and
send the generated speech to the audio output device;
wherein the audio output device plays the generated speech in response to the received request for the TTS generation.

10. The system as recited in claim 9, wherein the at least one pre-processed text entry is stored in a phonetic database.

11. The system as recited in claim 10, wherein phonetic database is stored on the memory.

12. The system as recited in claim 9, wherein the retrieved rules comprise instructions for the TTS engine to reformat the at least one text entry to a phonetic spelling different from standard spelling.

13. The system as recited in claim 9, wherein the retrieved rules comprise instructions for the TTS engine to remove at least one of a word, a phrase, or a punctuation item from the at least one text entry.

14. The system as recited in claim 9, wherein the retrieved rules comprise instructions for the TTS engine to replace at least one of a word, a phrase, or a punctuation item from the at least one text entry with a substitute item.

15. A method for pre-processing text for a text-to-speech (TTS) engine according to grammar rules, comprising:
receiving update data regarding the grammar rules;
updating the grammar rules according to the received update data;
receiving a request for TTS generation;
retrieving at least one text entry from a text information database;
applying the updated grammar rules to the at least one text entry to pre-process the at least one text entry; and
providing an audio output with TTS phonetics based at least in part on the at least one pre-processed text entry.

16. The method as recited in claim 15, further comprising storing the reformatted at least one text entry in a phonetic database.

17. The method as recited in claim 15, wherein receiving the update data comprises receiving the update data from a remote location.

18. The method as recited in claim 15, wherein applying the updated grammar rules comprises reformatting the at least one text entry to a phonetic spelling different from standard spelling.

19. The method as recited in claim 15, wherein applying the updated grammar rules comprises removing at least one of a word, a phrase, or a punctuation item from the at least one text entry.

20. The method as recited in claim 15, wherein applying the updated grammar rules comprises replacing at least one of a word, a phrase, or a punctuation item from the at least one text entry with a substitute item.
